(19) United States
(12) Patent Application Publication
(10) Pub. No.: US 2018/0234727 A1
(43) Pub. Date: Aug. 16, 2018

(54) DATA PROCESSING CIRCUIT OF DIGITAL TELEVISION AND METHOD THEREOF

(71) Applicant: MStar Semiconductor, Inc., Hsinchu Hsien (TW)

(72) Inventor: CHUN-CHIEH WANG, Hsinchu County (TW)

(21) Appl. No.: 15/883,136

(22) Filed: Jan. 30, 2018

Related U.S. Application Data
(60) Provisional application No. 62/459,551, filed on Feb. 15, 2017.

(51) Int. Cl. H04N 21/443; H04N 21/61; H04N 21/2315; H04N 21/433; H04N 21/426; H04N 21/438

(52) U.S. Cl. CPC H04N 21/4435; H04N 21/6118; H04N 21/6112; H04N 21/4382; H04N 21/433; H04N 21/42615; H04N 21/2315

(57) ABSTRACT

A data processing method applied to a multiplexing process and a bit de-interleaving process of a digital television is provided. The data processing method includes: storing a target OFDM symbol of OFDM symbols; generating a write address for each data bit of the target OFDM symbol according a sequence number of target OFDM symbol; generating a read address for each data bit of the target OFDM symbol according to a counter value; and writing each data bit of the target OFDM symbol into a memory according to the write addresses, and reading each data bit of the target OFDM symbol from the memory according to the read addresses. Each data bit of the target symbol is subjected to one write operation and one read operation. The target OFDM symbol read from the memory has completely undergone the multiplexing process and the bit de-interleaving process.

This application claims the benefit of U.S. Provisional Application Serial No. 62/459,551, filed Feb. 15, 2017, the subject matter of which is incorporated herein by reference.

### BACKGROUND OF THE INVENTION

### Field of the Invention

The invention relates to a digital television, and more particularly to a multiplexing process and a bit de-interleaving process of a digital television.

### Description of the Related Art

FIG. 1 shows a partial circuit of a Digital Video Broadcasting-Second Generation Terrestrial (DVB-T2) or Digital Video Broadcasting-Second Generation Cable (DVB-C2) receiving end. A de-mapping circuit 110 converts an orthogonal frequency division multiplexing (OFDM) symbol symbol_{q} to digital data bits b_{0,q}, b_{1,q}, . . . , b_{ηmod-1,q}, where q is a sequence number of the OFDM symbol, and one OFDM symbol symbol_{q} includes ηmod bits. For example, the value ηmod of 256 quadrature amplitude modulation (256 QAM) is 8, the value ηmod of 64 QAM is 6, and so forth.

A multiplexing processing unit 120 re-arranges the data bits of the OFDM symbol symbol_{q} by controlling orders of writing and reading the data bits of the OFDM symbol symbol_{q} into/from a memory. Taking a code rate of 256 QAM equal to ⅗ for example, the multiplexing processing unit 120 includes a 16-bit memory. The order for reading and writing the memory is as shown by the bit sorting rule shown in FIG. 2, wherein y0 to y15 are input bits, b0 to b15 are output bits, the 0^{th} output bit b0 corresponding to the 2^{nd} input bit y2, the 1^{st} output bit b1 corresponds to the 11^{th} input bit y11, the 2^{nd} output bit b2 corresponds to the 3^{rd} input bit, and so forth. A bit de-interleaving unit 130 writes the output bit bi outputted from the multiplexing processing unit 120 according to a predetermined write sequence to another memory, and reads the same according to a predetermined read sequence to complete the bit de-interleaving process. A low-density parity-check (LDPC) decoder 140 eventually decodes video data having undergone the bit de-interleaving process.

Because the multiplexing processing unit 120 and the bit de-interleaving unit 130 use different memories, a waste in memory is resulted. Further, multiple read and write operations performed by respective processing processes of the multiplexing processing unit 120 and the bit de-interleaving unit 130 degrade the overall circuit performance.

### SUMMARY OF THE INVENTION

It is an object of the present invention to provide a data processing circuit and a data processing method of a digital television so as to enhance performance of multiplexing and bit de-interleaving processes and save hardware resources.

The present invention discloses a data processing circuit applied to a multiplexing process and a bit de-interleaving process of a digital television. A de-mapping circuit of the digital television generates a plurality of orthogonal frequency division multiplexing (OFDM) symbols. The data processing circuit includes a buffer, a write address generating circuit, a read address generating circuit and a memory controller. The buffer is coupled to the de-mapping circuit, and stores a target OFDM symbol. The target OFDM symbol is one of the OFDM symbols. The write address generating circuit generates a write address for each data bit of the target OFDM symbol according to a sequence number of the OFDM symbol. The read address generating circuit generates a read address for each data bit of the target OFDM symbol according to a counter value. The memory controller writes each data bit of the target OFDM symbol into a memory according to the write addresses, and reads each data bit of the target OFDM symbol from the memory according to the read addresses. Each data bit of the target OFDM symbol is subjected to one write operation and one read operation, and the target OFDM symbol read from the memory has undergone the multiplexing process and the bit de-interleaving process.

The present invention further discloses a data processing method applied to a multiplexing process and a bit de-interleaving process of a digital television. A de-mapping circuit of the digital television generates a plurality of orthogonal frequency division multiplexing (OFDM) symbols. The data processing method includes: storing a target OFDM symbol, which is one of the OFDM symbols; generating a write address for each data bit of the target OFDM symbol according to a sequence number of the target OFDM symbol; generating a read address for each data bit of the target OFDM symbol according to a counter value; and writing each data bit of the OFDM symbol into a memory according to the write addresses and reading each data bit of the target OFDM symbol from the memory according to the read addresses. Each data bit of the target OFDM symbol is subjected to one write operation and one read operation, and the target OFDM symbol read from the memory has undergone the multiplexing process and the bit de-interleaving process.

The data processing circuit and data processing method for a digital television of the present invention are capable of completing a multiplexing process and a bit de-interleaving process after performing one write operation and one read operation. Compared to conventional solutions, the data processing circuit and the data processing method of the present invention enhance the performance of a digital television and save hardware resources. In certain operations, successive memory addresses are used for write operations or read operations, further enhancing access efficiency of the memory as well as the overall circuit performance.

The above and other aspects of the invention will become better understood with regard to the following detailed description of the embodiments. The following description is made with reference to the accompanying drawings.

### BRIEF DESCRIPTION OF THE DRAWINGS

FIG. 1 is a partial circuit of a conventional digital video receiving end;

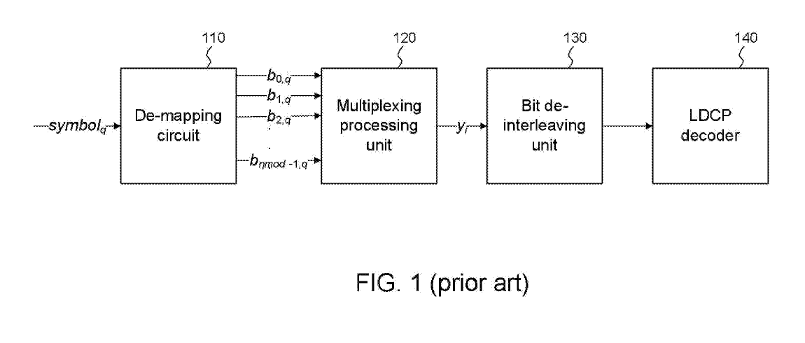

FIG. 2 is a schematic diagram of a bit sorting rule of a multiplexing process;

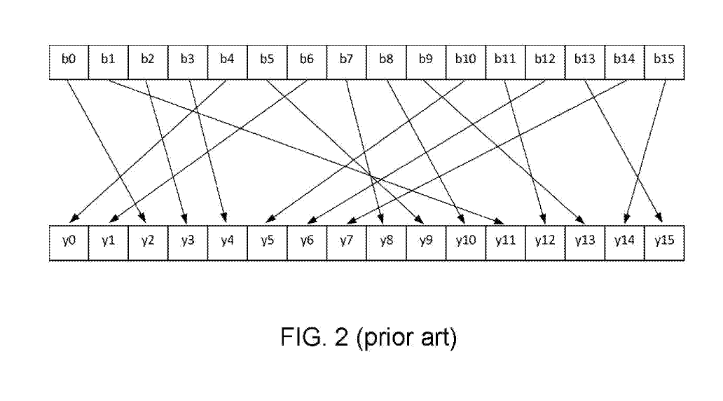

FIG. 3 is a partial circuit of a receiving end of a digital television of the present invention;

FIG. 4 is a detailed function block diagram of a data processing circuit according to an embodiment of the present invention;

FIG. 5 is a detailed function block diagram of a data processing circuit according to another embodiment of the present invention;

FIG. 6 is a detailed function block diagram of a data processing circuit according to yet another embodiment of the present invention;

FIG. 7 is a detailed function block diagram of a data processing circuit according to yet another embodiment of the present invention;

FIG. 8 is a schematic diagram of a storage space corresponding to an LDPC code in a memory; and

FIG. 9 is a flowchart of a data processing method according to an embodiment of the present invention.

### DETAILED DESCRIPTION OF THE INVENTION

The disclosure of the application includes a data processing circuit and a data processing method for a digital television. The data processing circuit and the data processing method are capable of enhancing the performance of the digital television and saving hardware resources, and are applicable to a receiving end of the digital television. In possible implementation, one person skilled in the art can choose equivalent elements or steps to realize the present invention based on the disclosure of the application; that is, the implementation of the present invention is not limited to the embodiments below.

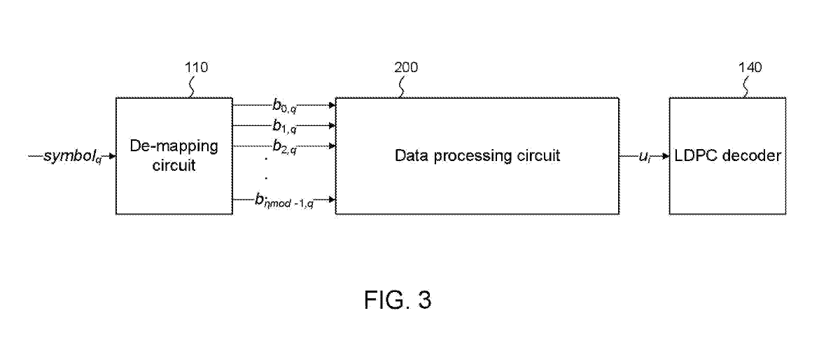

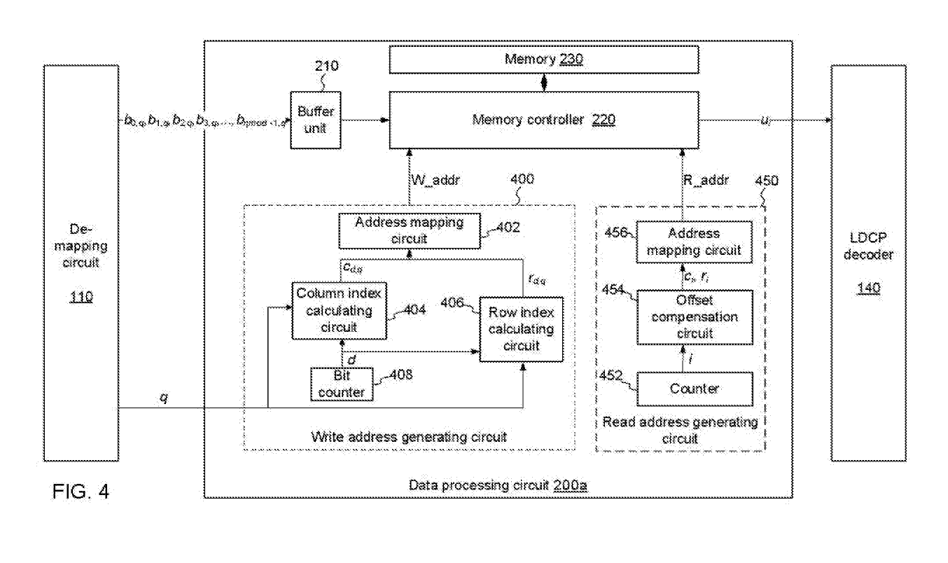

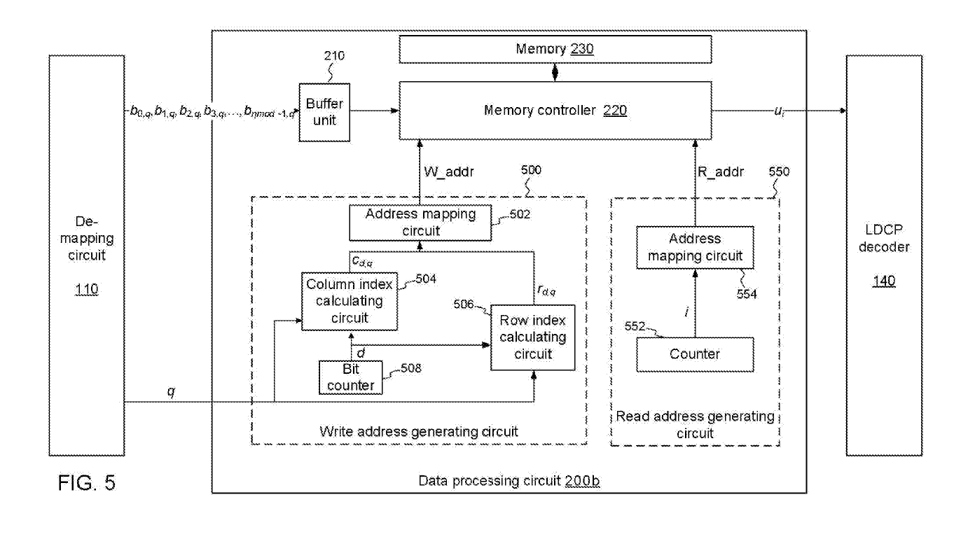

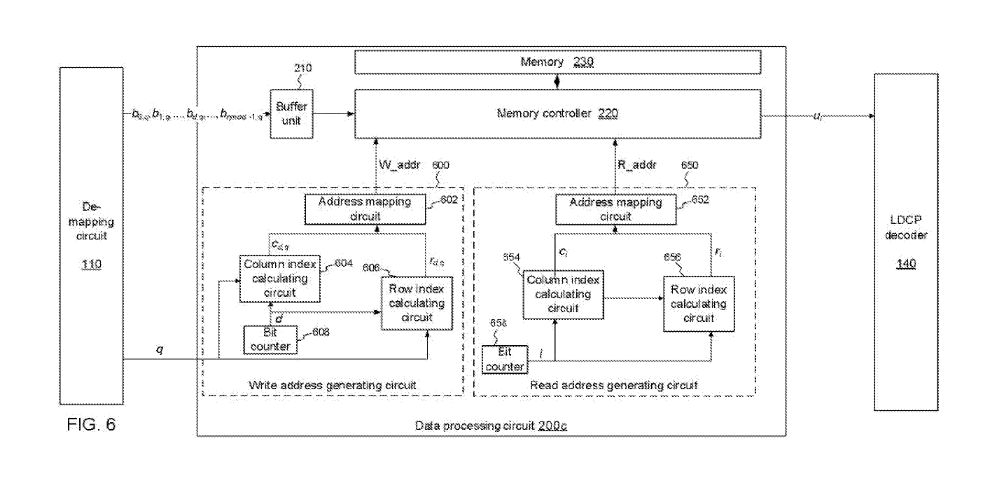

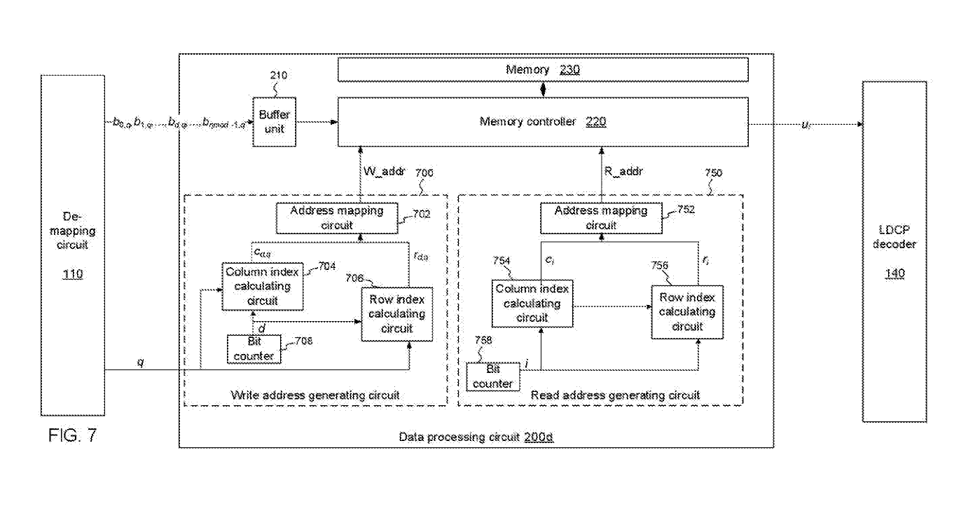

FIG. 3 shows a partial circuit of a receiving end of a digital television of the present invention. A data processing circuit 200 simultaneously performs a multiplexing process and a bit de-interleaving process on input data. According to different processing means on memory addresses with respect to write operations and read operations, the data processing circuit 200 of the present invention may include four different implementation methods, which respectively correspond to data processing circuits 200a to 200d in FIG. 4 to FIG. 7. In the embodiment in FIG. 4, write addresses are associated with a bit sorting rule of the multiplexing process, and read addresses are associated with offset compensation of the bit de-interleaving process. In the embodiment in FIG. 5, write addresses are associated with the bit sorting rule of the multiplexing process and offset compensation of the bit de-interleaving process. In the embodiment in FIG. 6, read addresses are associated with the bit sorting rule of the multiplexing process, and write addresses are associated with offset compensation of the bit de-interleaving process. In the embodiment in FIG. 7, read addresses are associated with the bit sorting rule of the multiplexing process and compensation offset of the bit de-interleaving process. The embodiments corresponding to FIG. 4 to FIG. 7 are described in detail below, taking 256 QAM as an example.

FIG. 4 shows a function block diagram of a data processing circuit according to an embodiment of the present invention. The data processing circuit 200a includes a buffer unit 210, a memory controller 220, a memory 230, a write address generating circuit 400 and a read address generating circuit 450. The memory controller 220 writes and reads, according to a write address W_addr generated by the write address generating circuit 400 and a read address R_addr generated by the read address generating circuit 450, data bits into and from the memory 230, so as to simultaneously complete a multiplexing process and a bit de-interleaving process. One target orthogonal frequency division multiplexing (OFDM) symbol among OFDM symbols outputted by the de-mapping circuit 110 includes data bits b_{0,q}, b_{1,q}, . . . , b_{ηmod-1,q}, which are buffered in the buffer unit 210. The de-mapping circuit 110 further outputs a sequence number q of the target OFDM symbol, where 0≤q<N_{LDPC}/ηmod, and N_{LDPC} is the length of one low-density parity-check (LDPC) code. Details of how the write address generating circuit 400 and the read address generating circuit 450 generate the write address W_addr and the read address R_addr are given below.

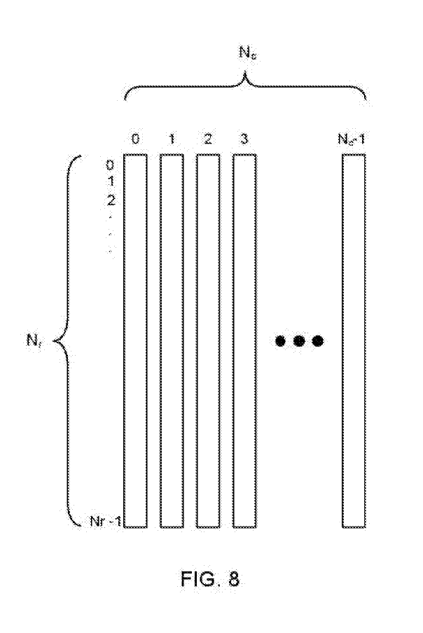

FIG. 8 shows a schematic diagram of a storage space corresponding to one LDPC code. Assuming that one LDPC code includes 64800 data bits (i.e., N_{LDPC}=64800) and the orthogonal amplitude modulation used is 256 QAM, the storage space can be configured to have a column number N_{c}=16 (columns) and a corresponding row number Nᵣ=4050 (=64800/16) (rows). Again referring to FIG. 4, the write address generating circuit 400 includes an address mapping circuit 402, a column index calculating circuit 404, a row index calculating circuit 406 and a bit counter 408. The bit counter 408 cyclically sequentially outputs a counter value d (0≤d<ηmod), i.e., d=0, 1, 2, . . . , d−1 , 0, 1, 2 . . . The column index calculating circuit 404 generates a column index c_{d,q} (0≤c_{d,q}<N_{c}) according to the sequence number q of the OFDM symbol and the counter value d of the bit counter 408. More specifically, the column index generating circuit 404 generates the c_{d,q} according to the rules in Table-1 and Table-2 below, wherein Table-1 is referred to when the sequence number q is an even number (including 0), and Table-2 is referred to when the sequence number q is an odd number. That is to say, the column index calculating circuit 404 generates the column index c_{d,q} according to a first sub-rule (Table-1) when the sequence number q is an even number, and generates the column index c_{d,q} according to a second sub-rule (Table-2) when the sequence number q is an odd number. More specifically, the write address W_addr is associated with the first sub-rule (Table-1) when the sequence number q is an even number, and is associated with the second sub-rule (Table-2) when the sequence number q is an odd number.

TABLE 1

| | | | | | | | | |
|---|---|---|---|---|---|---|---|---|
| d | 0 | 1 | 2 | 3 | 4 | 5 | 6 | 7 |
| c_{d, q} | 4 | 6 | 0 | 2 | 3 | 14 | 12 | 10 |

TABLE 2

| | | | | | | | | |
|---|---|---|---|---|---|---|---|---|
| d | 0 | 1 | 2 | 3 | 4 | 5 | 6 | 7 |
| c_{d, q} | 7 | 5 | 8 | 1 | 15 | 9 | 11 | 13 |

The row index calculating circuit 406 generates a row index r_{d,q} (0≤r_{d,q}<Nᵣ) according to the sequence number q of the OFDM symbol and the counter value d of the bit counter 408. More specifically, the row index calculating circuit 406 generates the row index r_{d,q} according to the rule below:

r_{d,q}=div(d+q×ηmod, N_{c}) . . . (1)

The address mapping circuit 402 eventually generates the write address W_addr according to an equation below:

W_addr_{d,q}=c_{d,q}×Nᵣ+r_{d,q} . . . (2)

In the read address generating circuit 450, an offset compensation circuit 454 generates a column index cᵢ and a row index rᵢ according to a counter value i outputted by a counter 452 as well as equation (3), and an address mapping circuit 456 then generates the read address R_addr according to the column index cᵢ, the row index rᵢ and equation (4):

$$\begin{matrix}\{ \begin{matrix}{c}_{i} = div ( i , {N}_{r} ) \\ {r}_{i} = mod ( i + {t}_{{c}_{i}} , {N}_{r} )\end{matrix} & ( 3 ) \\ {R\_addr}_{d , q} = {c}_{i} \times {N}_{r} + {r}_{i} & ( 4 )\end{matrix}$$

In the above, t_{c}_{ᵢ} is offset compensation of the bit de-interleaving process, and is in values represented as in Table-3 by taking Nᵣ=4050 and N_{c}=16 for example.

TABLE 3

| | | | | | | | | | | | | | | | | |
|---|---|---|---|---|---|---|---|---|---|---|---|---|---|---|---|---|
| cᵢ | 0 | 1 | 2 | 3 | 4 | 5 | 6 | 7 | 8 | 9 | 10 | 11 | 12 | 13 | 14 | 15 |
| t_{c}_{ᵢ} | 0 | 2 | 2 | 2 | 2 | 3 | 7 | 15 | 16 | 20 | 22 | 22 | 27 | 28 | 28 | 32 |

The memory controller 220 writes data into the memory 230 according to the write address W_addr, and reads the data from the memory 230 according to the read address R_addr to generate an output bit uᵢ having undergone the multiplexing process and the bit de-interleaving process. In this embodiment, the data processing circuit 200 takes into account the bit sorting rule of the multiplexing process in the write operation, and completes offset compensation of the bit de-interleaving process in the read operation, and so the data bit read from the memory has already undergone the multiplexing process and the bit de-interleaving process. More specifically, the data processing circuit 200 of the present invention can simultaneously complete the multiplexing process and the bit de-interleaving process after performing only one write operation and one read operation on the data bit generated by the de-mapping circuit 110, thus enhancing circuit performance while saving memory space.

FIG. 5 shows a function block diagram of a data processing circuit according to another embodiment of the present invention. A data processing circuit 200b includes a buffer unit 210, a memory controller 220, a memory 230, a write address generating circuit 500 and a read address generating circuit 550. The memory controller 220 writes and reads, according to the write address W_addr generated by the write address generating circuit 500 and the read address R_addr generated by the read address generating circuit 550, data bits into and from the memory 230 to simultaneously complete a multiplexing process and a bit de-interleaving process. Details of how the write address generating circuit 500 and the read address generating circuit 550 generate the write address W_addr and the read address R_addr are given below.

The write address generating circuit 500 includes an address mapping circuit 502, a column index calculating circuit 504, a row index calculating circuit 506 and a bit counter 508. The bit counter 508 cyclically sequentially outputs a counter value d, where 0≤d<ηmod. The column index calculating circuit 504 generates a column index c_{d,q} (0≤c_{d,q}<N_{c}) according to the sequence number q of the OFDM symbol and the counter value d of the bit counter 508. More specifically, the column index generating circuit 504 generates the column index c_{d,q}0≤c_{d,q}<N_{c} according to the rules in Table-1 and Table-2, wherein the first sub-rule (Table-1) is referred to when the sequence number q is an even number (including 0), and the second sub-rule (Table-2) is referred to when the sequence number q is an odd number.

The row index calculating circuit 506 generates a row index r_{d,q} (0≤r_{d,q}<Nᵣ) according to the sequence number q of the OFDM symbol and the counter value d of the bit counter 508, and takes into account the value of offset compensation t_{c}_{_{d,q}} of the bit de-interleaving process. More specifically, the row index calculating circuit 506 generates the row index r_{d,q} according to the rule of equation (5):

r_{d,q}=mod(div(d+q×ηmod, N_{c})−t_{c}_{_{d,q}}, Nᵣ) . . . (5)

Taking Nᵣ=4050 and N_{c}=16 for example, the value of the offset compensation t_{c}_{_{d,q}} is as shown in Table-4.

TABLE 4

| | | | | | | | | | | | | | | | | |
|---|---|---|---|---|---|---|---|---|---|---|---|---|---|---|---|---|
| c_{d, q} | 0 | 1 | 2 | 3 | 4 | 5 | 6 | 7 | 8 | 9 | 10 | 11 | 12 | 13 | 14 | 15 |
| t_{c}_{_{d, q}} | 0 | 2 | 2 | 2 | 2 | 3 | 7 | 15 | 16 | 20 | 22 | 22 | 27 | 28 | 28 | 32 |

The address mapping circuit 502 eventually generates the write address W_addr according to equation (6).

W_addr_{d,q}=c_{d,q}×Nᵣ+r_{d,q} . . . (6)

In the read address generating circuit 550, an address mapping circuit 554 generates the read address R_addr according to a counter value i (0≤i<N_{LDPC}) outputted by a counter 552 and equation (7):

$$\{ \begin{matrix}{c}_{i} = div ( i , {N}_{r} ) \\ {r}_{i} = mod ( i + {t}_{{c}_{i}} , {N}_{r} ) \\ {R\_addr}_{i} = {c}_{i} \times {N}_{r} + {r}_{i} = i\end{matrix} \qquad ( 7 )$$

The memory controller 220 writes data into the memory 230 according to the write address W_addr, and reads the data from the memory 230 according to the read address R_addr to generate an output bit uᵢ having undergone the multiplexing process and the bit de-interleaving process. Similarly, the data processing circuit 200 of the present invention is capable of simultaneously completing the multiplexing process and the bit de-interleaving process after performing only one write operation and only read operation on the data bit generated by the de-mapping circuit 110. Further, in this embodiment, because the data processing circuit 200 has already taken into account both the bit sorting rule of the multiplexing process and the offset compensation of the bit de-interleaving process while writing the data bits into the memory 230, successively reading the data bits can be carried out when reading the data bits from the memory 230 (i.e., R_addrᵢ=i), further enhancing reading performance of the memory 230.

FIG. 6 shows a function block diagram of a data processing circuit according to another embodiment of the present invention. A data processing circuit 200c includes a buffer unit 210, a memory controller 220, a memory 230, a write address generating circuit 600 and a read address generating circuit 650. The memory controller 220 writes and reads, according to the write address W_addr generated by the write address generating circuit 600 and the read address R_addr generated by the read address generating circuit 650, data bits into and from the memory 230 to simultaneously complete a multiplexing process and a bit de-interleaving process. Details of how the write address generating circuit 600 and the read address generating circuit 650 generate the write address W_addr and the read address R_addr are given below.

The write address generating circuit 600 includes an address mapping circuit 602, a column index calculating circuit 604, a row index calculating circuit 606 and a bit counter 608. The bit counter 608 cyclically sequentially outputs a counter value d, where 0≤d<ηmod. The column index calculating circuit 604 generates a column index c_{d,q} (0≤c_{d,q}<N_{c}) according to the sequence number q of the OFDM symbol and the counter value d of the bit counter 608. More specifically, the column index generating circuit 604 generates the column index c_{d,q} according to equation (8).

c_{d,q}=d+mod(q, N_{c}/ηmod)×ηmod . . . (8)

The row index calculating circuit 606 generates a row index r_{d,q} (0≤r_{d,q}<Nᵣ) according to the sequence number q of the OFDM symbol and the counter value d of the bit counter 608. More specifically, the row index calculating circuit 606 generates the row index r_{d,q} according to equation (9).

r_{d,q}=mod(div(d+q×ηmod, N_{c})−t_{c}_{_{d,q}}, Nᵣ) . . . (9)

In the above, t_{c}_{ᵢ} is offset compensation of the bit de-interleaving process, and has values represented as in Table-4. The address mapping circuit 402 eventually generates the write address W_addr according to equation (10):

W_addr_{d,q}=C_{d,q}+r_{d,q}×N_{c} . . . (10)

The read address generating circuit 650 includes an address mapping circuit 652, a column index calculating circuit 654, a row index calculating circuit 656 and a counter 658. The column index calculating circuit 654 calculates an intermediate value bᵢ according to the counter value i (0≤i<N_{LDPC}) outputted by the counter 658 as well as equation (11), and generates a column index cᵢ according to the intermediate value bᵢ and Table-5.

bᵢ=div(i, Nᵣ) . . . (11)

TABLE 5

| | | | | | | | | | | | | | | | | |
|---|---|---|---|---|---|---|---|---|---|---|---|---|---|---|---|---|
| bᵢ | 0 | 1 | 2 | 3 | 4 | 5 | 6 | 7 | 8 | 9 | 10 | 11 | 12 | 13 | 14 | 15 |
| cᵢ | 2 | 11 | 3 | 4 | 0 | 9 | 1 | 8 | 10 | 13 | 7 | 14 | 6 | 15 | 5 | 12 |

The row index calculating circuit 656 obtains a row index rᵢ according the counter value i outputted by the counter 658 as well as equation (12).

rᵢ=mod(i, Nᵣ) . . . (12)

The address mapping circuit 652 eventually obtains the read address R_addr according to the column index cᵢ, the row index rᵢ and equation (13):

R_addrᵢ=cᵢ+rᵢ×N_{c} . . . (13)

The memory controller 220 writes data into the memory 230 according to the write address W_addr, and reads the data from the memory 230 according to the read address R_addr to generate an output bit uᵢ having undergone the multiplexing process and the bit de-interleaving process. In this embodiment, the data processing circuit 200 completes offset compensation of the bit de-interleaving process in the write operation, and takes into account the bit sorting rule of the multiplexing process in the read operation, and so the data bit read from the memory has already undergone the multiplexing process and the bit de-interleaving process. More specifically, the data processing circuit 200 of the present invention can simultaneously complete the multiplexing process and the bit de-interleaving process after performing only one write operation and one read operation on the data bit generated by the de-mapping circuit 110, thus enhancing circuit performance while saving memory space.

FIG. 7 shows a function block diagram of a data processing circuit according to another embodiment of the present invention. The data processing circuit 200d includes a buffer unit 210, a memory controller 220, a memory 230, a write address generating circuit 700 and a read address generating circuit 750. The memory controller 220 writes and reads, according to the write address W_addr generated by the write address generating circuit 700 and the read address R_addr generated by the read address generating circuit 750, data bits into and from the memory 230 to simultaneously complete a multiplexing process and a bit de-interleaving process. Details of how the write address generating circuit 700 and the read address generating circuit 750 generate the write address W_addr and the read address R_addr are given below.

The write address generating circuit 700 includes an address mapping circuit 702, a column index calculating circuit 704, a row index calculating circuit 706 and a bit counter 708. The bit counter 708 cyclically sequentially outputs a counter value d, where 0≤d<ηmod. The column index calculating circuit 704 generates a column index c_{d,q} (0≤c_{d,q}<N_{c}) according to the sequence number q of the OFDM symbol and the counter value d of the bit counter 508. More specifically, the column index generating circuit 504 generates the column index c_{d,q} according equation (14).

c_{d,q}=d+mod(q, N_{c}/ηmod)×ηmod . . . (14)

The row index calculating circuit 706 generates a row index r_{d,q} (0≤r_{d,q}<Nᵣ) according to the sequence number q of the OFDM symbol and the counter value d of the bit counter 708. More specifically, the row index calculating circuit 706 generates the row index r_{d,q} according to equation (15):

r_{d,q}=div(d+q×μmod, N_{c})=div(q, N_{c}/ηmod) . . . (15)

The address mapping circuit 702 eventually generates the write address W_addr according to an equation below:

$${W}_{{addr}_{d , q}} = {c}_{d , q} + {r}_{d , q} \times {N}_{c} = d + mod ( q , {N}_{c} / ηmod ) \times ηmod + div ( q , ηmod / {N}_{c} ) = d + q \times 8 \qquad ( 16 )$$

In fact, because the counter d=0, 1, 2, . . . , ηmod−1, 0, 1, 2 . . . , and the sequence number q=0, 1, 2 . . . , W_{addr}_{_{d,q}}=d+q×8=0, 1, 2, . . . N _{LDPC}−1 is in fact a successive value; that is to say, in this embodiment, the memory controller 220 writes the data bits at successive addresses of the memory 230, further enhancing the writing performance of the memory 230.

The read address generating circuit 750 includes an address mapping circuit 752, a column index calculating circuit 754, a row index calculating circuit 756 and a counter 758. The column index calculating circuit 754 calculates an intermediate value bᵢ according to the counter value i (0≤i<N_{LDPC}) and equation (17), and then generates a column index cᵢ according to the intermediate value bᵢ and Table-5.

bᵢ=div(i, Nᵣ) . . . (17)

The row index calculating circuit 756 obtains a row index rᵢ according the counter value i outputted by the counter 758 and equation (18).

rᵢ=mod(i+t_{c}_{ᵢ}, Nᵣ) . . . (18)

In the above, t_{c}_{ᵢ} is offset compensation of the bit de-interleaving process, and has values represented as in Table-3 by taking Nᵣ=4050 and N_{c}=16 for example. The address mapping circuit 752 eventually obtains the read address R_addr according to the column index cᵢ, the row index rᵢ and equation (19):

R_addrᵢ=cᵢ+rᵢ×N_{c} . . . (19)

The memory controller 220 writes data into the memory 230 according to the write address W_addr, and reads the data from the memory 230 according to the read address R_addr to generate an output bit uᵢ having undergone the multiplexing process and the bit de-interleaving process. In this embodiment, because the data processing circuit 200 has, in the reading process, already taken into account both the bit sorting rule of the multiplexing process and the offset compensation of the bit de-interleaving process, successively writing the data bits can be carried out when writing the data bit from the memory 230 (i.e., W_addrᵢ=i), further enhancing writing performance of the memory 230.

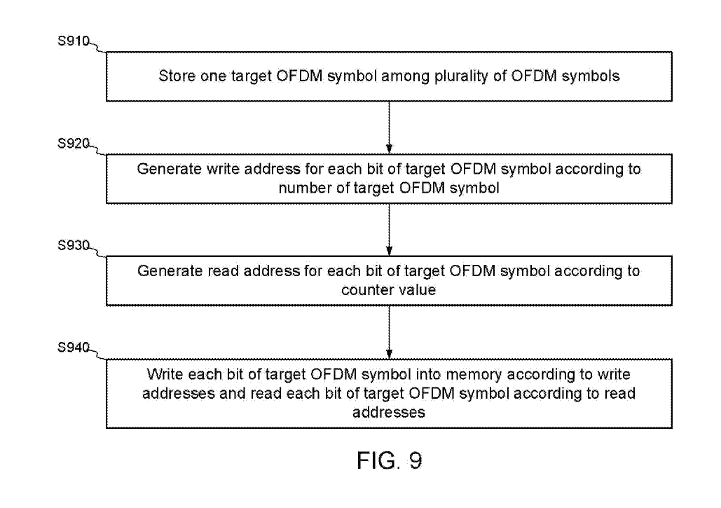

In addition to the foregoing data processing circuit, the present invention correspondingly discloses a data processing method, which can be performed by the foregoing data processing circuit 200 or an equivalent device. FIG. 9 shows a flowchart of the method according to an embodiment. Referring to FIG. 9, the method includes following steps.

In step S910, a target OFDM symbol among a plurality of OFDM symbols is stored.

In step S920, a write address is generated for each bit of the target OFDM symbol according to a sequence number of the target OFDM symbol.

In step S930, a read address is generated for each bit of the target OFDM symbol according to a counter value.

In step S940, each bit of the target OFDM symbol is written into a memory according to the write addresses, and each bit of the target OFDM symbol is read from the memory according to the read addresses.

Details of steps S910 to S940 are as described in the embodiments in FIG. 4 to FIG. 7, and shall be omitted herein. Steps S910 to S940 are capable of simultaneously completing a multiplexing process and a bit de-interleaving process after performing only one write operation and one read operation on a data bit. Although 256 QAM code rate equal to ⅗ is taken as an example in the embodiments, the present invention is applicable to other modulation schemes, e.g., 16 QAM and 64 QAM. For different modulation schemes and code rates, the data processing circuit of the present invention can adapt to these modulation schemes and code rates by appropriately setting or modifying the values in Table-1 to Table-5. The foregoing data bits b_{0,q}, b_{1,q}, . . . , b_{ηmod-1,q} may include a plurality of soft bits.

One person skilled in the art can easily understand implementation details and variations based on the disclosure of the device of the present invention, and these details shall be omitted herein. While the invention has been described by way of example and in terms of the embodiments, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A data processing circuit, applied for a multiplexing process and a bit de-interleaving process of a digital television, a de-mapping circuit of the digital television generating a plurality of orthogonal frequency division multiplexing (OFDM) symbols, the data processing circuit comprising:
a buffer, coupled to the de-mapping circuit, storing a target OFDM symbol, which is one among the plurality of OFDM symbols;
a write address generating circuit, generating a write address for each data bit of the target OFDM symbol according to a sequence number of the target OFDM symbol;
a read address generating circuit, generating a read address for each data bit of the target OFDM symbol according to a counter value; and
a memory controller, writing each data bit of the target OFDM symbol into a memory according to the write addresses, and reading each data bit of the OFDM symbol from the memory according to the read addresses;
wherein, each data bit of the target OFDM symbol is subjected to one write operation and one read operation, and the target OFDM symbol read from the memory has completely undergone the multiplexing process and the bit de-interleaving process.

2. The data processing circuit according to claim 1, wherein the write address generating circuit and the read address generating circuit respectively generate the write addresses and the read addresses according to one of the following methods: (1) the write addresses are associated with a bit sorting rule of the multiplexing process and an offset compensation of the bit de-interleaving process; (2) the write addresses are associated with the bit sorting rule, and the read addresses are associated with the offset compensation; (3) the read addresses are associated with the bit sorting rule and the offset compensation; and (4) the read addresses are associated with the bit sorting rule, and the write addresses are associated with the offset compensation.

3. The data processing circuit according to claim 2, wherein in the method (1), the read addresses are successive.

4. The data processing circuit according to claim 2, wherein in the method (3), the write addresses are successive.

5. The data processing circuit according to claim 2, wherein the bit sorting rule comprises a first sub-rule and a second sub-rule; and in the methods (1) or (2), the write address generating circuit generates the write addresses according to the first sub-rule when the sequence number is an even number, and generates the write addresses according to the second sub-rule when the sequence number is an odd number.

6. A data processing method, applied for a multiplexing process and a bit de-interleaving process of a digital television, a de-mapping circuit of the digital television generating a plurality of orthogonal frequency division multiplexing (OFDM) symbols, the data processing method comprising:
storing a target OFDM symbol, which is one among the OFDM symbols;
generating a write address for each data bit of the target OFDM symbol according to a sequence number of the OFDM symbol;
generating a read address for each data bit of the OFDM symbol according to a counter value; and
writing each data bit of the target OFDM symbol into a memory according to the write addresses, and reading each data bit of the target OFDM symbol from the memory according to the read addresses;
wherein, each data bit of the target OFDM symbol is subjected to one write operation and one read operation, and the target OFDM symbol read from the memory has completely undergone the multiplexing process and the bit de-interleaving process.

7. The data processing method according to claim 6, wherein the write addresses and the read addresses are generated according to one of the following methods: (1) the write addresses are associated with a bit sorting rule of the multiplexing process and an offset compensation of the bit de-interleaving process; (2) the write addresses are associated with the bit sorting rule, and the read addresses are associated with the offset compensation; (3) the read addresses are associated with the bit sorting rule and the offset compensation; and (4) the read addresses are associated with the bit sorting rule, and the write addresses are associated with the offset compensation.

8. The data processing method according to claim 7, wherein in the method (1), the read addresses are successive.

9. The data processing method according to claim 7, wherein in the method (3), the write addresses are successive.

10. The data processing method according to claim 7, wherein the bit sorting rule comprises a first sub-rule and a second sub-rule; in the method (1) or (2), the write addresses are generated according to the first sub-rule when the sequence number is an even number, and are generated according to the second sub-rule when the sequence number is an odd number.
